(19) United States
(12) Patent Application Publication
(10) Pub. No.: US 2025/0182168 A1
(43) Pub. Date: Jun. 5, 2025

(54) System and Method for Evaluating Organizations Seeking Funding on an Online Platform

(71) Applicant: Frederick Bethel, Orlando, FL (US)

(72) Inventor: Frederick Bethel, Orlando, FL (US)

(21) Appl. No.: 18/959,867

(22) Filed: Nov. 26, 2024

Related U.S. Application Data
(60) Provisional application No. 63/605,689, filed on Dec. 4, 2023.

(51) Int. Cl. G06Q 30/0282; G06Q 30/018; G06Q 30/0279

(52) U.S. Cl. CPC G06Q 30/0282; G06Q 30/0185; G06Q 30/0279

(57) ABSTRACT

A system and method for evaluating organizations seeking funding on an online platform is provided. The system utilizes multiple key performance indicators (KPIs) to dynamically assess and present an organization's performance through a real-time, rating system. The KPIs include donor star ratings, photo upload frequency, routine activity updates, financial reporting, and response times to donor inquiries. A data integration module collects and aggregates information from various sources, while a weight assignment module dynamically adjusts the relevance of each KPI. The system allows donors to view detailed breakdowns of individual rating factors, including transparency, responsiveness, and financial accountability, while also providing an overall score. Additionally, a real-time alert mechanism informs organizations of their vetting status and any further requirements for approval of acceptance onto the online platform. The system promotes transparency and accountability, enabling donors to make informed funding decisions.

### CROSS REFERENCE TO RELATED APPLICATION

This application claims the benefit of pending U.S. Provisional Application No. 63/605,689 filed on Dec. 4, 2023; the above identified patent application is herein incorporated by reference in its entirety.

### BACKGROUND OF THE INVENTION

The present invention relates to a system and method for evaluating organizations seeking funding on an online platform. More specifically, the invention addresses the need for real-time, data-driven evaluations of charitable and nonprofit organizations by integrating multiple data sources and providing transparent, standardized performance metrics. The invention is particularly useful for enhancing transparency and accountability in the charitable giving sector, where donors require reliable information to make informed decisions about which organizations to support.

Online fundraising platforms have become increasingly popular, providing a convenient and accessible means for individuals to contribute to charitable causes. These platforms break down geographical barriers and enable donors to engage with a diverse range of organizations. However, this growth has also exposed donors to the risks of fraudulent or underperforming organizations, many of which may present misleading information regarding their activities, finances, or legitimacy. The absence of effective tools for real-time evaluation makes it difficult for donors to verify whether their contributions are being used responsibly.

Current systems for evaluating organizations on online platforms typically rely on static, manual processes or limited data points, such as user reviews or self-reported updates from organizations. These systems lack the ability to provide comprehensive, real-time insights into an organization's ongoing performance. As a result, donors are often left with incomplete or outdated information, making it challenging to assess the credibility, transparency, and effectiveness of organizations before donating.

The problem of fraudulent or mismanaged organizations in the charitable sector has created an urgent need for a reliable and scalable system that can dynamically evaluate an organization's performance based on multiple data sources. This includes real-time inputs such as customer reviews, financial transparency, response times to donor inquiries, and updates on how donations are being applied. Furthermore, there is a need for a system that can assign standardized, objective evaluation metrics that provide a clear picture of an organization's trustworthiness, responsiveness, and transparency.

The present invention addresses these issues by providing a technological solution that integrates data from diverse sources and processes it using dynamic weighting algorithms to generate real-time performance evaluations. The system's real-time alert mechanism ensures that organizations and donors are notified immediately when there are changes in performance metrics or when additional data is required. By offering an automated, objective, and comprehensive evaluation system, the invention enhances the transparency and accountability of organizations seeking funding, helping donors make more informed decisions.

Unlike existing evaluation systems that rely on static data or manual reviews, the present invention introduces an automated, real-time system that continually updates its evaluations based on current data inputs. The system provides donors with a detailed breakdown of key performance indicators, such as financial accountability, responsiveness, and transparency, presented through a rating system, such as a 5-star rating system. This dynamic evaluation process not only addresses the immediate concerns of fraudulent activity but also supports the ongoing assessment of an organization's operational effectiveness over time.

In light of the limitations of known systems and methods in the field, the present invention substantially diverges from existing solutions by providing a scalable, real-time evaluation platform that automates the collection, aggregation, and analysis of organizational data. The invention introduces a novel approach to assessing organizations seeking funding, offering a transparent, consistent, and objective metric for evaluating their performance.

### SUMMARY OF THE INVENTION

In view of the foregoing disadvantages inherent in the known types of evaluation systems and methods now present in the known art, the present invention provides a new system and method for evaluating organizations seeking funding on an online platform.

It is an objective of the present invention to provide a system and method for evaluating organizations seeking funding on an online platform that integrates a plurality of data sources, including donor star ratings, photo upload frequency, routine updates, financial reporting, and response times to donor inquiries. The system collects and aggregates data through a data integration module, enabling comprehensive performance evaluations. The evaluation framework is adapted to provide consistency and transparency by dynamically weighting the relevance of each data source and presenting results through a standardized 5-star rating system.

It is an objective of the present invention to provide a system and method for evaluating organizations seeking funding on an online platform that fosters transparency and accountability by offering detailed breakdowns of performance metrics. The system's user interface displays individual KPI scores, historical data, and real-time updates, allowing donors to evaluate organizational performance comprehensively.

It is an objective of the present invention to provide a system and method for evaluating organizations seeking funding on an online platform that automates the evaluation process by incorporating dynamic notifications and alerts. These notifications prompt organizations to upload photos, provide routine updates, complete financial reports, and respond to donor inquiries within predefined timelines. In this way, manual intervention is reduced, timely task completion is promoted, and up-to-date ratings for all organizations on the platform is maintained.

It is an objective of the present invention to provide a system and method for evaluating organizations seeking funding on an online platform that calculates an overall evaluation metric based on dynamically weighted KPI scores. The metric generator processes real-time data to produce a composite star rating, reflecting the organization's performance across key criteria. In this way, fairness and accuracy in the evaluation process, with ratings that adapt to ongoing organizational activities and donor engagement is achieved.

It is an objective of the present invention to provide a system and method for evaluating organizations seeking funding on an online platform that enhances donor engagement through smartphone notifications and interactive features. Notifications inform donors about updates such as new photos, financial reports, or responses to questions, while the user interface allows donors to explore detailed evaluations.

It is an objective of the present invention to provide a system and method for evaluating organizations seeking funding on an online platform that supports the submission and integration of structured and unstructured data, such as 990 forms, Articles of Incorporation, and donor feedback.

It is an objective of the present invention to provide a system and method for evaluating organizations seeking funding on an online platform that employs a historical performance module to store and display past evaluations, allowing donors to analyze trends in organizational performance over time.

It is an objective of the present invention to provide a system and method for evaluating organizations seeking funding on an online platform that includes a recommendation engine for donors. The recommendation engine suggests organizations based on donor preferences, past interactions, and KPI scores, simplifying the process of identifying organizations that align with donor priorities and interests.

It is therefore an object of the present invention to provide a new and improved system and method for evaluating organizations seeking funding on an online platform that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a block diagram of an embodiment of the system and method for evaluating organizations seeking funding on an online platform.

FIG. 2 shows a view of a user interface of an embodiment of the system and method for evaluating organizations seeking funding on an online platform.

FIG. 3 shows another view of a user interface of an embodiment of the system and method for evaluating organizations seeking funding on an online platform.

FIG. 4 shows a flow chart of an embodiment of the system and method for evaluating organizations seeking funding on an online platform.

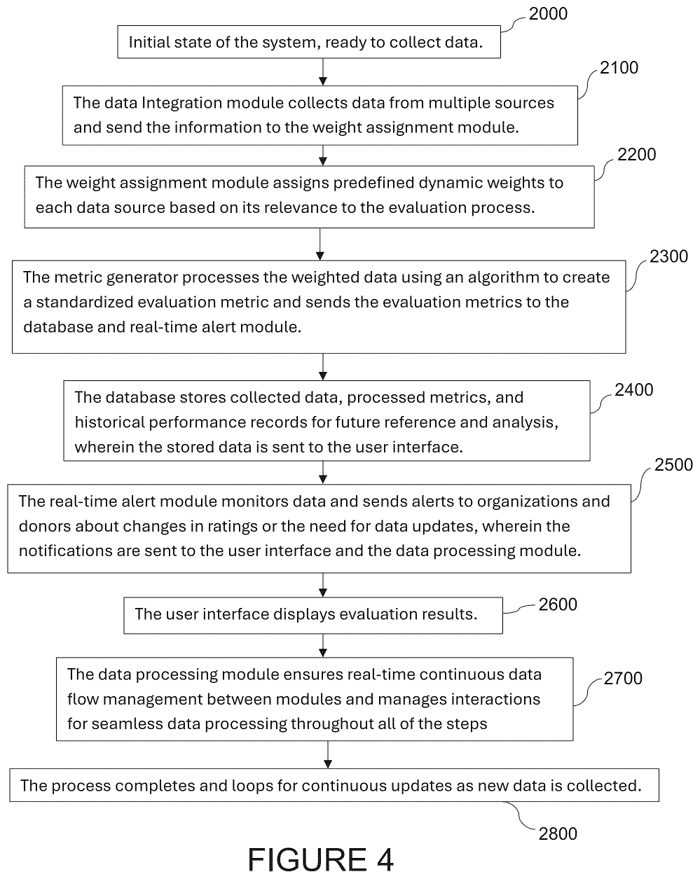

### DETAILED DESCRIPTION OF THE INVENTION

Reference is made herein to the attached drawings. Like reference numerals are used throughout the drawings to depict like or similar elements of the system. For the purpose of presenting a brief and clear description of the present invention, the embodiment discussed will be used for housing for evaluating organizations seeking funding on an online platform. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment,” “first embodiment,” “second embodiment,” or “third embodiment” does not necessarily refer to the same embodiment.

As used herein, “computer-readable medium” or “memory” excludes any transitory signals, but includes any non-transitory data storage circuitry, e.g., buffers, cache, and queues, within transceivers of transitory signals. As used herein, “logic” refers to (i) logic implemented as computer instructions and/or data within one or more computer processes and/or (ii) logic implemented in electronic circuitry.

For purposes of this patent, the term “organization” refers to an entity that interacts with the system through an electronic device capable of sending or receiving information, such as a computer, smartphone, or other network-connected device. Similarly, the term “donor” or “donor device” denotes that any communication, data exchange, or interaction with the system occurs through an electronic device capable of sending or receiving information, such as a computer, smartphone, or other network-connected device. Therefore, when the system is described as sending or receiving information to or from a donor or organization, it is understood that such communication involves the electronic donor device or electronic organization device, which facilitates these interactions with the system.

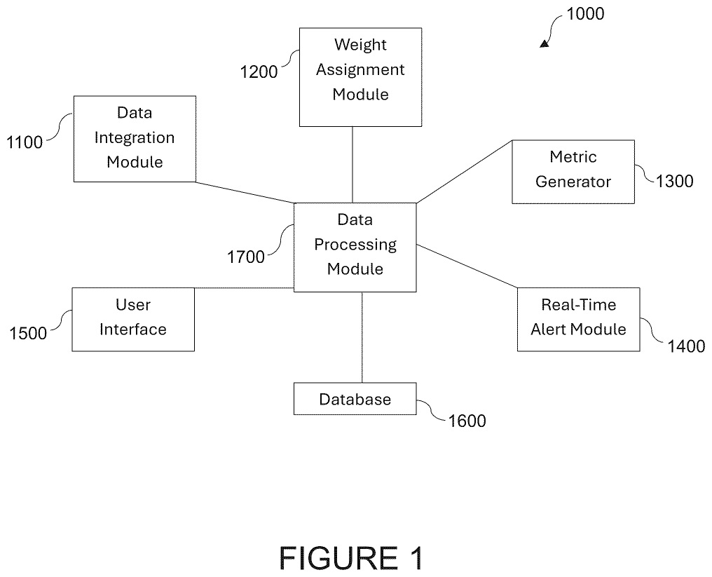

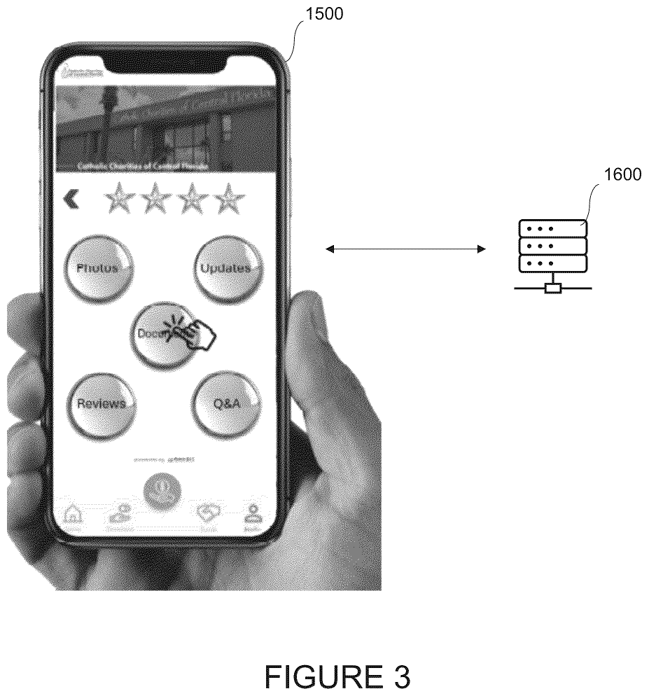

Referring now to FIGS. 1-3, there is shown a block diagram of an embodiment of the system and method for evaluating organizations seeking funding on an online platform and view of a user interface of an embodiment of the system and method for evaluating organizations seeking funding on an online platform, respectively. The present invention provides a system for evaluating organizations seeking funding on an online platform through a rating system. Unlike conventional methods that focus on static evaluations or limited data sources, this invention introduces a dynamic, real-time rating system that leverages multiple data streams and advanced data processing techniques to provide transparent and actionable insights into organizational performance. By integrating data from multiple sources, applying dynamic weighting, and generating standardized evaluation metrics, the system addresses the technical challenge of providing real-time accountability for organizations on online platforms.

The rating system comprises a plurality of key performance indicators (KPIs) that contribute to evaluating an organization or charity on a 5-star rating system. In the illustrated embodiment, the KPIs include donor star ratings, photo upload frequency, routine activity updates, financial reporting, and response times to donor inquiries. Each KPI is determined after data is collected from a distinct source by a data integration module 1100. In the illustrated embodiment, the data integration module 1100 configured to collect, aggregate, and standardize disparate data types from various sources in real time. The data integration module 1100 is operably connected to a communication network that allows the system to search the internet for sources. The system 1000 further comprises a software platform that is configured to receive and send information to both a donor and an organization. The sources provide information relevant to the stability, trustworthiness, and health of the organization seeking funding on the software platform.

The data integration module 1100 collects data from various sources, including but not limited to customer online review ratings or donor star ratings, photos of activities, organizational structure, organizational updates, response times to donor inquiries, and financial reports. However, in alternate embodiments, the system comprises more or less sources. The data integration module 1100 is configured to handle data from both structured and unstructured sources allowing information to be efficiently integrated into the system regardless of its format or origin. By automating this process, the data integration module 1100 eliminates the need for manual data entry and significantly improves the scalability and speed of the evaluation process. This provides a technical advantage over existing systems that rely on more static or manual data collection.

The system 1000 further comprises a weight assignment module 1200, which assigns specific weights to each data source. In the illustrated embodiment, each KPI within the rating system is assigned a maximum weight of 5 points, contributing to the averaging formula used to determine the overall star rating. The weight assignment module applies predefined rules to ensure that each KPI is appropriately weighted, and the rating reflects donor and organizational activities within the system. The weight assignment module 1200 applies predefined rules for assigning weights to different types of data, ensuring that the most critical factors (e.g., financial reports, third-party validations) are given more importance in the evaluation process, while other factors (e.g., customer reviews) are weighted accordingly. In the illustrated embodiment, the weight assignment process is not static—it can be dynamically adjusted based on real-time data updates and changes in donor behavior. This capability allows the system to solve the technical challenge of adjusting to evolving information in real time, providing a more accurate and responsive evaluation framework than traditional systems. The weighted data is then forwarded to the metric generator 1300 for further processing.

The weight assignment module 1200 can be selectively adjusted by a system administrator depending on the relevance of a data source to the organization. For example, if the organization is a service-oriented company, the system 1000 is configured to increase the weight, via the weight assignment module, of the organization's response time to a customer inquiry. Whereas if the organization is a charity, the system is configured to increase the weight, via the weight assignment module, of donation updates. The weight assignment module 1200 assigns a specific weight to each data source based on the significance to the organization and the donor or customer.

Once the data is properly weighted by the weight assignment module, each data source is assigned a rating that is established by a metric generator 1300. The metric generator computes the overall star rating using an averaging formula that combines the total points earned from each KPI. For instance, if the combined average from all KPIs equals 4.5 points, the organization will receive a 4.5-star rating. This structured evaluation approach ensures fairness, accuracy, and transparency.

The system 1000 further comprises a real-time alert module 1400 designed to provide immediate notifications to organizations and donors when specific events occur, such as changes in an organization's rating or the detection of incomplete or inconsistent data. The real-time alert module 1400 allows for real-time communication between the system 1000 and its users, offering dynamic updates that reflect the organization's current status. For example, if an organization's response time to donor inquiries exceeds a predefined threshold, the system can automatically lower the organization's rating and notify both the donor and the organization. This real-time feedback mechanism improves the technological capabilities of the system by ensuring that evaluations are always up-to-date and actionable. Additionally, the real-time alert module 1400 helps organizations rectify performance issues before they negatively impact their overall rating, providing a more interactive and responsive evaluation process compared to static systems.

In some embodiments, the system 1000 comprises a user interface 1500 configured to provide donors with comprehensive, real-time access to evaluation data. The user interface 1500 displays both the overall rating system and detailed breakdowns of individual ratings for specific performance metrics, such as organizational transparency, responsiveness, financial updates, and third-party reporting. Unlike traditional evaluation systems that might only present summary information, the user interface 1500 allows donors to interact with the data at a granular level, offering detailed insights into an organization's operations and performance. This interactive capability represents a technical improvement over conventional platforms by allowing users to explore different aspects of the organization's performance, enabling better-informed decision-making. In the illustrated embodiment, the system 1000 also provides historical performance data, allowing donors to track how an organization's ratings have evolved over time, further enhancing the transparency and usability of the platform.

A database 1600 stores all real-time and historical data, including the raw data collected from external sources and the processed metrics generated by the system 1000. The database 1600 is configured to handle high volumes of data efficiently, ensuring that the system can scale to accommodate a large number of organizations and donors. It also supports secure storage and retrieval of sensitive data, such as third-party validation reports, regulatory filings, and financial disclosures. By enabling fast and secure access to both current and historical data, the database 1600 solves the technical problem of managing complex, large-scale datasets in real time, which is essential for maintaining accurate and up-to-date evaluations.

In some embodiments, the system 1000 further comprises a data processing module 1700 configured to coordinate the flow of data between the various components of the system. The data processing module allows data collected by the data integration module 1100 to be correctly weighted, processed by the metric generator 1300, and displayed in real time via the user interface 1500.

In the illustrated embodiment, the donor star rating weight is based on a manual rating selection given by a donor, representing the experience they have had with the organization. The predefined rule within the weight assignment module comprises a one through five star rating received by a donor within a 30-day increment that a donor has donated money to the organization. In the illustrated embodiment, if donations are given within a 30-day period, the system will send a prompt to the donor through a user interface to rate their experience with the organization by selecting up to 5 stars representing their like or dislike of the experience. The donor will only be able to provide this rating when prompted by the system. This prompt to allow an opportunity to rate will represent an automated action by the system portal and not a donor-initiated action.

In the illustrated embodiment, the weighting of this KPI is calculated based on the aggregated star ratings provided by all the donors for each organization. In an illustrated example, the weight assignment module assigns the following rating or stars for the donor rating KPI—5 stars=50 responses; 4 stars=25 responses; 3 stars=20 responses; 2 stars=15 responses; 1 star=10 responses or less. With a total of 120 responses, the calculation becomes: Score total: 50(5)+25(4)+20(3)+15(2)+10(1)=450. Response total: 50+25+20+15+10=120. 5-star score: 450/120=3.75, which rounds to 3.8. This calculated score is then incorporated into the overall rating for the organization, contributing to its 5-star evaluation system.

In the illustrated embodiment, the weighting of the photo upload frequency by an organization to its profile page on the system is based on the number of image files that are received by the system from the organization within a two-week period. The system 1000 sends notifications to the donor via their smartphone notification settings once the system receives an image file from the organization. The ability of the organization to provide ongoing photo content in a timely manner will determine its weight score for this KPI. The system will also send notification reminders to the organization prior to each expiration benchmark to ensure the timely completion of the task and the maintenance of a maximum weight score.

In the illustrated embodiment, the photo upload frequency and corresponding weight are as follows: Within 1-14 days of the last upload=maintain 5.0, Within 15-28 days of the last upload=drops to 4.5, Within 29-42 days of the last upload=drops to 4.0, Within 43-56 days of the last upload=drops to 3.5, Within 57-70 days of the last upload=drops to 3.0, Within 71-84 days of the last upload=drops to 2.5, Within 85-98 days of the last upload=drops to 2.0, Within 99-112 days of the last upload=drops to 1.5, Within 113-126 days of the last upload=drops to 1.0, Within 127-140 days of the last upload=drops to 0.5, More than 141 days since the last upload=drops to 0. This weighting system incentivizes organizations to regularly provide photo content, ensuring donors receive consistent updates on activities. The calculated weight score for this KPI is incorporated into the overall evaluation metric.

In the illustrated embodiment, the weighting of the routine activity updates is determined by the frequency that the system receives non-image updates from the organization. Once a routine activity update is received by the system from the organization, the system sends a notification to the donor device of the update. The donor can also view these updates directly on the user interface of the software platform. The weight of this KPI is determined by the time between the current and last update. Regular updates ensure that donors remain informed about the efforts and progress being made by the organization. Additionally, the system will send notification reminders to the organization prior to each expiration benchmark, prompting them to maintain a maximum weight score.

The update frequency and corresponding weight are as follows: Within 1-14 days of the last update=maintain 5.0, Within 15-28 days of the last update=drops to 4.5, Within 29-42 days of the last update=drops to 4.0, Within 43-56 days of the last update=drops to 3.5, Within 57-70 days of the last update=drops to 3.0, Within 71-84 days of the last update=drops to 2.5, Within 85-98 days of the last update=drops to 2.0, Within 99-112 days of the last update=drops to 1.5, Within 113-126 days of the last update=drops to 1.0, Within 127-140 days of the last update=drops to 0.5, More than 141 days since the last update=drops to 0. This weighting incentivizes organizations and charities to provide consistent and timely updates on their activities, keeping donors engaged and informed. The calculated weight score for this KPI is incorporated into the overall evaluation metric.

In the illustrated embodiment, the weighting of the financial reporting by an organization is determined by the organization completing a 90-Day review worksheet provided through the software platform of the system. The worksheet forms the basis of financial and activity disclosure and can be reviewed by donors on the organization profile page of the user interface once completed. In some embodiments, the organization is required to upload supplemental documents, such as 990 forms and Articles of Incorporation, as part of the reporting process. The weight for this KPI is determined by the timeline for completing the worksheet, measured in 90-day cycles from the last 90-Day review report. Notification reminders will be sent to the organization prior to each expiration benchmark to encourage timely completion and maintenance of a maximum weight score.

Financial reporting completion weights are as follows: 80-90 days from last report=5.0, 91-100 days from last report=4.5, 101-110 days from last report=4.0, 111-120 days from last report=3.5, 121-130 days from last report=3.0, 131-140 days from last report=2.5, 141-150 days from last report=2.0, 151-160 days from last report=1.5, 161-170 days from last report=1.0, 171-180 days from last report=0.5, More than 180 days since the last report=0.0.

In the illustrated embodiment, the weighting of the organization's response time to donor questions posed through the software is determined by the duration between an organization response and the donor posed question. When a donor submits a question regarding the organization's activities, the response time is measured from when the question is received by the system via the software platform. Notification alerts are then sent to the organization to prompt a timely response. The answers provided by the organization will be visible to all viewers on the organization profile page, promoting transparency and accountability. Notification reminders will also be sent to organizations prior to response deadlines to encourage adherence to benchmarks and ensure maximum weight scores.

The response time and weight are as follows: Within 1-2 days to respond=maintain 5.0, Within 3-4 days to respond=drops to 4.5, Within 5-6 days to respond=drops to 4.0, Within 7-8 days to respond=drops to 3.5, Within 9-10 days to respond=drops to 3.0, Within 11-12 days to respond=drops to 2.5, Within 13-14 days to respond=drops to 2.0, Within 15-16 days to respond=drops to 1.5, Within 17-18 days to respond=drops to 1.0, Within 19-20 days to respond=drops to 0.5, More than 21 days to respond=drops to 0.

The weight values for all KPIs, including financial reporting, response times, routine updates, donor ratings, and photo uploads, contribute live and continuously to the overall rating system. The rating is calculated as the average of the combined KPI weights, which is then converted into the corresponding star rating. For example, if the average KPI weight is 4.6, the rating will reflect 4.6 stars. This dynamic system ensures that the star rating accurately reflects an organization's ongoing performance and responsiveness.

In the illustrated embodiment, the metric generator 1300 is configured to process the weighted data from the weight assignment module 1200 to generate standardized evaluation metrics. The metric generator 1300 uses an algorithm to analyze the aggregated data streams and produce a rating system that reflects the organization's performance across multiple criteria, including transparency, responsiveness, financial accountability, and engagement. By applying this algorithm, the system ensures that the evaluation is objective and based on a consistent, predefined set of criteria. This structured evaluation process enhances the technical functionality of the system by automating the complex process of calculating and presenting real-time performance metrics, which would otherwise require manual intervention or static approaches. The metric generator is configured to establish a standardized evaluation metric for assessing the legitimacy and eligibility of organizations as charity entities via the plurality of sources. The ratings can be averaged or viewed independently to determine if an organization, such as a charity organization seeking funding, to help a donor decide the best organizations to fund.

The system 1000 provides a comprehensive, real-time system for evaluating organizations seeking funding on an online platform. By integrating dynamic data collection, real-time weighting adjustments, and proprietary metric generation algorithms, the system solves the technical challenges of delivering transparent, accurate, and actionable evaluations to donors. These improvements distinguish the invention from abstract ideas and generic data-processing systems by demonstrating concrete technological innovations that improve the functionality of online fundraising platforms and empower donors to make more informed decisions.

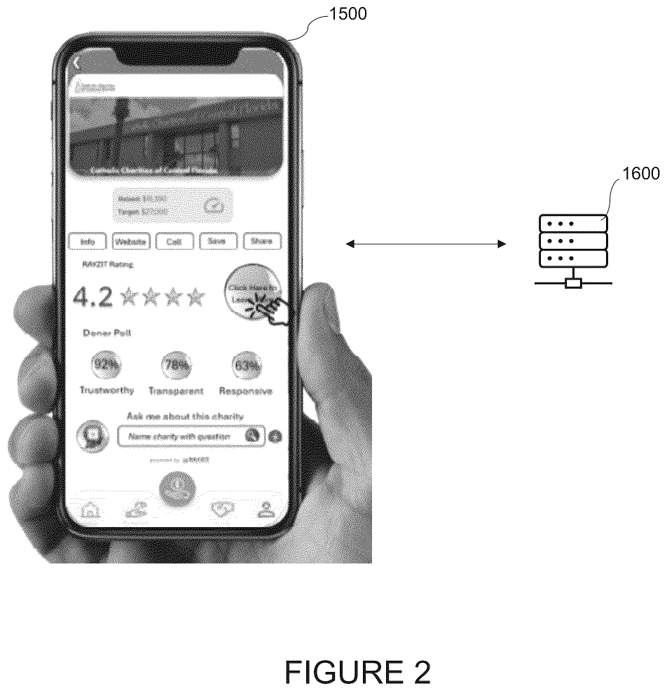

Referring now to FIG. 2, there is shown a flow chart of an embodiment of the system and method for evaluating organizations seeking funding on an online platform. The present invention further provides a method for evaluating organizations seeking funding on an online platform. The process 2000 begins with the data integration module which collects data 2100 from various sources such as customer reviews, photos, organizational updates, response times, and financial reports. This collected data is aggregated and prepared for further processing. The method then proceeds to the weight assignment module, where each data source is assigned a specific weight based on predefined rules that determine its relevance to the overall evaluation process 2200. This weighted data is forwarded to the metric generator, which processes the information using a proprietary algorithm to generate standardized evaluation metrics 2300. These metrics include a comprehensive 5-star rating and individual scores that assess an organization's transparency, responsiveness, and financial accountability.

The metric generator comprises a logic, that when executed by a processor causes the following: collecting data from the plurality of sources via the data integration module; averaging the online review ratings identified via a communication network, wherein the online review ratings are relevant to the organization; assigning a first rating to an average of the online review ratings; determining a number of organizational updates provided by the organization; assigning a second rating to the number of organizational updates; averaging the response time of the organization when an input is received from a donor; assigning a third rating to the response time; receiving the donation update from the organization; determining a donation update response time and assigning a fourth rating to the donation update; determining if an organizational structure is received; assigning a fifth rating to the organization structure determination; determining if third party reporting has been received by the donor; and assigning a sixth rating to the third party reporting.

The generated metrics and ratings are stored in the database 2400, which securely maintains both real-time and historical performance data for each organization. This stored data supports future analysis and provides a foundation for consistent updates. Simultaneously, the real-time alert module continuously monitors data for significant changes 2500. If a notable shift in an organization's performance or data completeness is detected, the module sends alerts to both the organization and donors, ensuring real-time feedback and prompt actions.

Next, the user interface presents the evaluation results 2600, displaying both the overall rating and detailed breakdowns of individual performance metrics to donors. This interface allows for user interaction and the exploration of data to make informed funding decisions. The data processing module manages data flow between components and facilitating real-time updates and interactions across the system 2700. The method concludes with the system looping 2800 to ensure continuous data collection, real-time analysis, and updates, maintaining the accuracy and currency of the evaluations provided to users.

The rating system is distinct from external third-party ranking or rating criteria, such as Google Play, Apple App Store, Yelp, or Trustpilot, as the overall rating solely relies on activities conducted within the parameters of the system portal. Each key performance indicator carries a maximum weight of 5 points, which contributes to the averaging formula used to determine the overall star rating. An organization can achieve a maximum total of 5 points, reflecting their rating based on the combined average derived from each KPI's total points earned. Each overall average point corresponds to a star, such that a 5-point average results in a 5-star rating, a 4-point average results in a 4-star rating, a 3-point average results in a 3-star rating, a 2-point average results in a 2-star rating, and a 1-point average results in a 1-star rating. The system ensures fairness and accuracy by dynamically regulating and weighting these KPIs based on donor and organizational activities within the platform experience.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for evaluating organizations seeking funding on an online platform, comprising:
a data integration module configured to collect and aggregate data from a plurality of data sources, wherein the plurality of data sources includes a donor star rating, a photo upload frequency, routine activity updates, financial reporting, and a response time to donor inquiries;
wherein each data source is assigned a specific weight via a weighing process based on a set of predefined rules, the weighting process being dynamically adjustable based on real-time data updates;
a metric generator configured to process the weighted data from the data integration module and generate an evaluation metric for assessing an organization based on data received for the organization;
wherein the organization is a remote computing device configured receive information and send information;
a user interface configured to present the rating of the organization, wherein the user interface allows a donor to view the rating of the organization;
wherein the metric generator having a logic, that when executed by a processor causes the following:
collecting data from the plurality of sources via the data integration module;
averaging a number of donor star ratings received by the system;
assigning a first rating to the number of donor star ratings;
determining a frequency of image files received by the system from the organization;
assigning a second rating to the frequency of image files received;
receiving a donor inquiry and sending the inquiry to the organization;
determining a response time of the organization when an input is received from the organization;
assigning a third rating to the response time;
receiving a routine activity update from the organization;
determining a frequency of the routing activity update and assigning a fourth rating to the routing activity update;
sending a financial reporting section to the organization;
receiving the financial reporting section completed from the organization and determining a duration until the system received the completed financial reporting section;
assigning a fifth rating to the duration;
incorporating the first through fifth ratings in an overall rating for the organization;
posting the overall rating on the user interface.

2. The system of claim 1, further comprising a real-time alert module configured generate real-time notifications to the organization and to a donor when the organization's rating changes below a pre-determined threshold.

3. The system of claim 1, wherein the metric generator further comprises a dynamic weighting adjustment mechanism, wherein the weights assigned to data sources are modified in real-time based on new incoming data and/or donor interactions.

4. The system of claim 1, wherein the user interface provides the donor with access to a historical performance report for each organization, showing how the organization's ratings for responsiveness, transparency, and financial updates have evolved over time.

5. The system of claim 1, wherein the donor star ratings are calculated based on feedback provided by donors at 30-day increments, and the system automatically prompts donors to rate their experience, preventing donor-initiated actions.

6. The system of claim 5, wherein the donor star ratings are calculated as a weighted average based on the star selections, and the calculated score is incorporated into the overall evaluation metric.

7. The system of claim 1, further comprising a weight assignment module configured to adjust the weights assigned to each data source based on organization feedback.

8. The system of claim 1, further comprising an AI-based data analysis engine that is configured to identify patterns in the collected data to detect potential signs of fraud or mismanagement.

9. The system of claim 1, wherein the user interface includes a filter that allows the donor to sort and search organizations based on specific criteria, including highest transparency ratings, fastest response times, and/or the most frequent donation updates.

10. The system of claim 1, wherein the photo uploads is evaluated based on the frequency of uploads by the organization, and weight values decrease incrementally based on the time elapsed since the last upload, with a maximum score maintained for uploads within a 14-day timeframe.

11. The system of claim 1, wherein the routine activity updates is evaluated based on the frequency of updates provided by the organization, with weight values decreasing incrementally as the time delta between the current and last update increases, and a maximum score maintained for updates within a 14-day timeframe.

12. The system of claim 1, wherein the financial reporting requires the organization to complete a 90-day review worksheet provided by the system portal with weight values decreasing incrementally for delays beyond 90 days from the previous submission.

13. The system of claim 1, wherein the response time evaluates the time taken by an organization to respond to donor questions submitted through the system portal, with weight values decreasing incrementally for response times exceeding 2 days and the questions and responses displayed publicly on the organization's profile page.

14. The system of claim 1, wherein the composite evaluation metric is calculated as the average of the scores from the donor star ratings, photo uploads, routine updates, financial reporting, and response times, and the composite score is converted into a star rating.

15. The system of claim 14, wherein the composite star rating is dynamically updated based on real-time changes to each individual rating.

16. The system of claim 1, further comprising a real-time alert module configured to notify the organization of pending or overdue tasks and to alert the donor of updates, uploaded content, or responses to their inquiries.

17. The system of claim 1, wherein the user interface allows the donor to view a breakdown of each rating.

18. The system of claim 1, further comprising a recommendation engine that suggests a new organization to the donor based on past donations, ratings, and selected performance criteria.
